(19) United States
(12) Patent Application Publication
(10) Pub. No.: US 2025/0062440 A1
(43) Pub. Date: Feb. 20, 2025

(54) BATTERY PACK STRUCTURE FOR VEHICLE

(71) Applicants: Hyundai Motor Company, Seoul (KR); Kia Corporation, Seoul (KR)

(72) Inventors: Gyung Hoon Shin, Seoul (KR); Jong Gyu Park, Hwaseong-si (KR)

(21) Appl. No.: 18/606,345

(22) Filed: Mar. 15, 2024

(30) Foreign Application Priority Data
Aug. 16, 2023 (KR) 10-2023-0107062

(51) Int. Cl. H01M 10/6556; H01M 10/613; H01M 10/658; H01M 50/204; H01M 50/249

(52) U.S. Cl. CPC H01M 10/6556; H01M 10/613; H01M 10/658; H01M 50/204; H01M 50/249; H01M 2220/20

(57) ABSTRACT

An embodiment battery pack structure for a vehicle includes a supplying channel configured to supply a refrigerant, a discharging channel disposed such that the refrigerant flows therein in parallel with the supplying channel, and a plurality of cooling channels disposed in parallel between the supplying channel and the discharging channel such that the refrigerant can flow under a plurality of battery modules disposed between the supplying channel and the discharging channel.

### CROSS-REFERENCE TO RELATED APPLICATIONS

This application claims the benefit of Korean Patent Application No. 10-2023-0107062, filed on Aug. 16, 2023, which application is hereby incorporated herein by reference.

### TECHNICAL FIELD

The disclosure relates to a structure of a battery pack mounted to a vehicle.

### BACKGROUND

An electric vehicle or the like includes an electric motor to generate a driving force for the vehicle and a battery pack to supply electric power to the electric motor.

The battery pack accommodates a plurality of battery modules, and a plurality of battery cells are overlapped to make up the battery module.

To increase the range of the vehicle, the battery pack needs to accommodate more battery modules or battery cells therein. Further, to ensure appropriate crash performance of the vehicle, a plurality of reinforcing members is required in the battery pack.

In other words, when the plurality of reinforcing members is provided in the battery pack to ensure the crash performance of the vehicle, it is disadvantageous for increasing the range of the vehicle because the number of battery modules or battery cells accommodated in the battery pack is reduced. On the other hand, when the reinforcing members in the battery pack are decreased to accommodate more battery modules in the battery pack, it is disadvantageous for ensuring the crash performance of the vehicle because the rigidity of the battery pack is lowered.

Meanwhile, the battery cells making up the battery module are required to be properly cooled, and uniform cooling performance, which ensures that the battery cells of all the battery modules accommodated in the battery pack are cooled as evenly as possible, is a critical factor in ultimately determining the durability of the battery pack.

The matters described as the related art are merely intended to promote the understanding of the background of embodiments of the disclosure but should not be accepted as recognition of the prior art that has already been known to a person having ordinary knowledge in the art.

### SUMMARY

An embodiment of the disclosure provides a battery pack structure for a vehicle, which ensures uniform and excellent cooling performance so that all battery cells accommodated in a battery pack can be cooled as evenly as possible, thereby ultimately improving the durability of the battery pack.

According to an embodiment of the disclosure, a battery pack structure for a vehicle includes a supplying channel provided to supply a refrigerant, a discharging channel formed to make the refrigerant flow in parallel with the supplying channel, and a plurality of cooling channels provided in parallel between the supplying channel and the discharging channel so that the refrigerant can flow under a plurality of battery modules disposed between the supplying channel and the discharging channel.

Each of the supplying channel and the discharging channel may be formed to make the refrigerant flow straightly, and the plurality of cooling channels may connect the supplying channel and the discharging channel in straight lines to form a cooling plane on an upper side thereof.

The plurality of battery modules may be mounted on the cooling panel, and an insulator may be provided below the plurality of battery modules arranged in sequence along a lengthwise direction of the cooling channel and may cause a difference in heat transfer performance according to relative positions from the supplying channel.

The insulator may be disposed forming layers as heterogeneous materials in the cooling plane formed above the cooling channel.

The insulator may include a first insulator attached to the cooling plane and a second insulator attached to a top of the first insulator.

The first insulator may be attached along an outward portion shape of the bottom of the battery module and have a narrower area as it is positioned further away from the supplying channel.

The first insulator attached along the outward portion shape of the bottom of the battery module may be formed so that an area in a portion further from the supplying channel can be narrower than an area in a portion closer to the supplying channel.

The first insulator attached to the bottom of the battery module closest to the discharging channel among the plurality of battery modules arranged in sequence along the lengthwise direction of the cooling channel may have a structure in which a portion closest to the discharging channel is removed from portions corresponding to the outward portion shape of the bottom of the battery module to form a U-shape.

The second insulator attached to the top of the first insulator may be locally provided only on a portion closest to the supplying channel among outward bottom portions of each battery module.

The battery pack structure may further include a gap filler between the bottom of the battery module and the cooling plane, between the bottom of the battery module and the first insulator, and between the bottom of the battery module and the second insulator.

The insulator may be attached along an outward portion shape of the bottom of the battery module and have a narrower area as it is positioned further away from the supplying channel.

The insulator provided along the outward portion shape of the bottom of the battery module may be formed so that an area in a portion further from the supplying channel can be narrower than an area in a portion closer to the supplying channel.

The insulator attached to the bottom of the battery module closest to the discharging channel among the plurality of battery modules arranged in sequence along the lengthwise direction of the cooling channel may have a structure in which a portion closest to the discharging channel is removed from portions corresponding to the outward portion shape of the bottom of the battery module to form a U-shape.

The insulator may be attached to the cooling plane formed by the plurality of cooling channels, and a gap filler may be provided between the bottom of the battery module and the cooling plane and between the bottom of the battery module and the insulator.

The supplying channel and the discharging channel may be configured as both side members of the battery pack, respectively.

The cooling plane formed by the plurality of cooling channels may be parallel to the lengthwise direction of both side members, and a frontward wall and a rearward wall may be respectively provided in the fronts and rears of both side members, so that the plurality of battery modules can be accommodated in an accommodating space formed by both side members, the frontward wall, and the rearward wall.

The battery pack structure may further include a single longitudinal member, both ends of which are supported on the frontward wall and the rearward wall across the accommodating space, and a single transverse member having both ends supported on both side members across the accommodating space and intersecting the longitudinal member.

The cooling channel may be formed by a plurality of extruded panels provided on a lower side of the accommodating space, and the cooling plane is formed by a top surface of the plurality of extruded panels.

According to embodiments of the disclosure, there is provided a battery pack structure for a vehicle, which ensures uniform and excellent cooling performance so that all battery cells accommodated in a battery pack can be cooled as evenly as possible, thereby ultimately improving the durability of the battery pack.

### BRIEF DESCRIPTION OF THE DRAWINGS

FIG. 1 is a view depicting a battery pack structure for a vehicle according to embodiments of the disclosure.

FIG. 2 is a view depicting the battery pack structure of FIG. 1, from which an upper cover is removed.

FIG. 3 is a plan view of the battery pack structure of FIG. 2, from which battery modules are removed and to which a gap filler is applied.

FIG. 4 is a view depicting the battery pack structure of FIG. 3, from which the gap filler is removed exposing a first insulator and a second insulator.

FIG. 5 is a view depicting only parts that make up a supplying channel, a cooling channel, and a discharging channel in FIG. 4.

FIG. 6 is a perspective view of the battery pack structure cut along line VI-VI of FIG. 5.

FIG. 7 is a perspective view of the battery pack structure cut along line VII-VII of FIG. 5.

FIG. 8 is a view illustrating the battery pack structure with the first insulator of FIG. 4.

FIG. 9 is an enlarged view depicting a portion of FIG. 8.

FIG. 10 is a cross-sectional view taken along line X-X of FIG. 4.

### DETAILED DESCRIPTION OF ILLUSTRATIVE EMBODIMENTS

Hereinafter, embodiments of the disclosure will be described in detail with reference to the accompanying drawings, in which the same or similar elements are denoted by the same reference numerals even though they are depicted in different drawings and redundant descriptions thereof will be avoided.

Suffixes “module” and “unit” put after elements in the following description are given in consideration only of ease of description and do not have meaning or functions discriminated from each other.

In terms of describing the embodiments of the disclosure, detailed descriptions of the related art will be omitted when they may make the subject matter of the embodiments of the disclosure rather unclear. In addition, the accompanying drawings are provided only for a better understanding of the embodiments of the disclosure and are not intended to limit technical ideas of the disclosure. Therefore, it should be understood that the accompanying drawings include all modifications, equivalents, and substitutions within the scope and spirit of the disclosure.

Terms such as “first” and “second” may be used to describe various components, but the components should not be limited by the above terms. In addition, the above terms are used only for the purpose of distinguishing one component from another.

When it is described that one component is “connected” or “joined” to another component, it should be understood that the one component may be directly connected or joined to another component, but additional components may be present therebetween. However, when one component is described as being “directly connected” or “directly coupled” to another component, it should be understood that additional components may be absent between the one component and another component.

Unless the context clearly dictates otherwise, singular forms include plural forms as well.

In the disclosure, it should be understood that term “include” or “have” indicates that a feature, a number, a step, an operation, an element, a part, or the combination thereof described in the embodiments is present, but does not preclude a possibility of presence or addition of one or more other features, numbers, steps, operations, elements, parts, or combinations thereof, in advance.

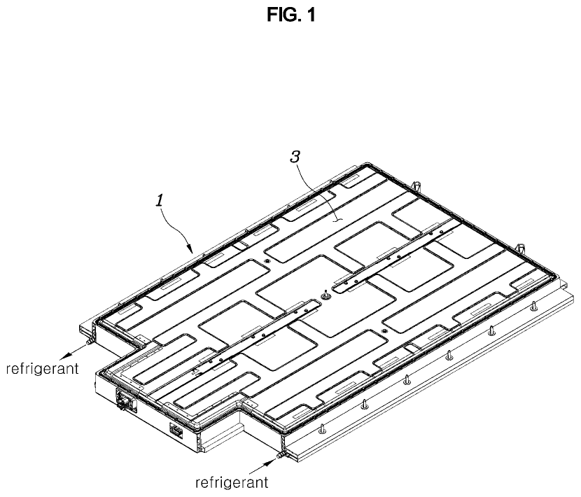

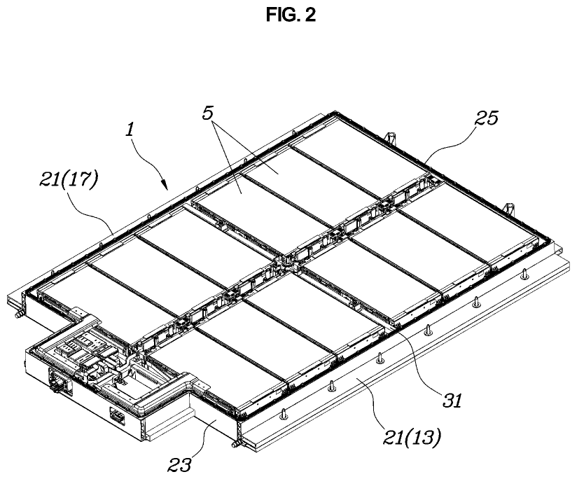

FIG. 1 is a view depicting the outer structural appearance of a battery pack 1 for a vehicle according to embodiments of the disclosure, and FIG. 2 is a view depicting the battery pack structure of FIG. 1 from which an upper cover 3 is removed.

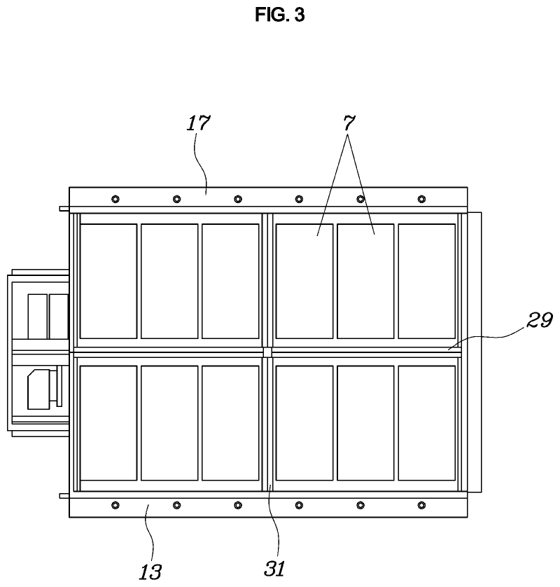

FIG. 3 is a plan view of the battery pack structure of FIG. 2, from which battery modules 5 on an upper side are removed and to which a gap filler 7 is applied.

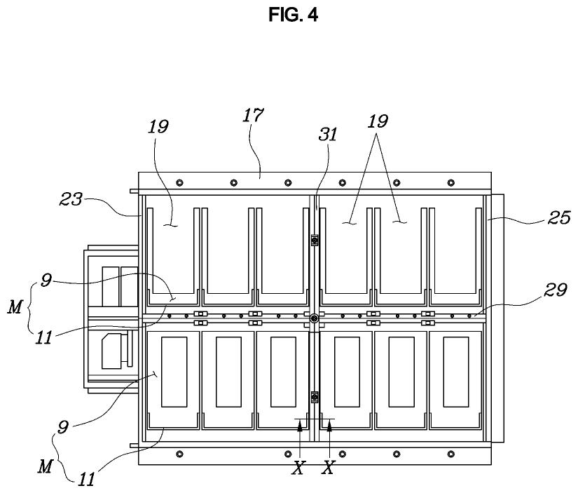

FIG. 4 is a view depicting the battery pack structure of FIG. 3, from which the gap filler 7 is removed exposing a first insulator 9 and a second insulator 11 below the gap filler 7.

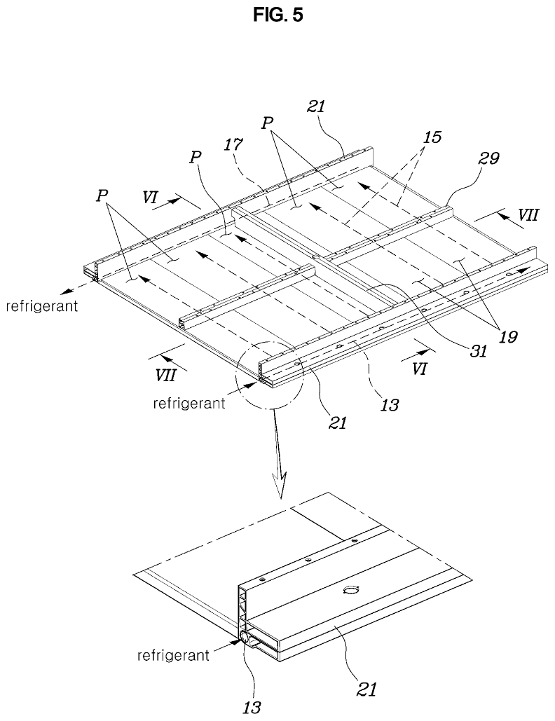

FIG. 5 is a view depicting only parts that make up a supplying channel 13, a cooling channel 15, and a discharging channel 17 in FIG. 4, in which the arrows represent the flow of a refrigerant.

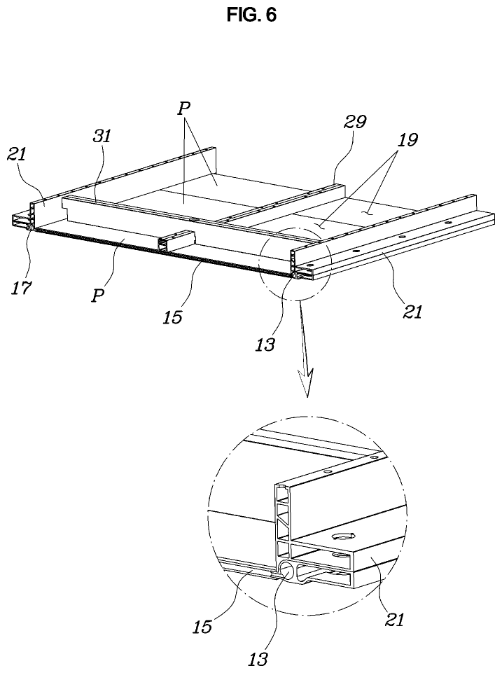

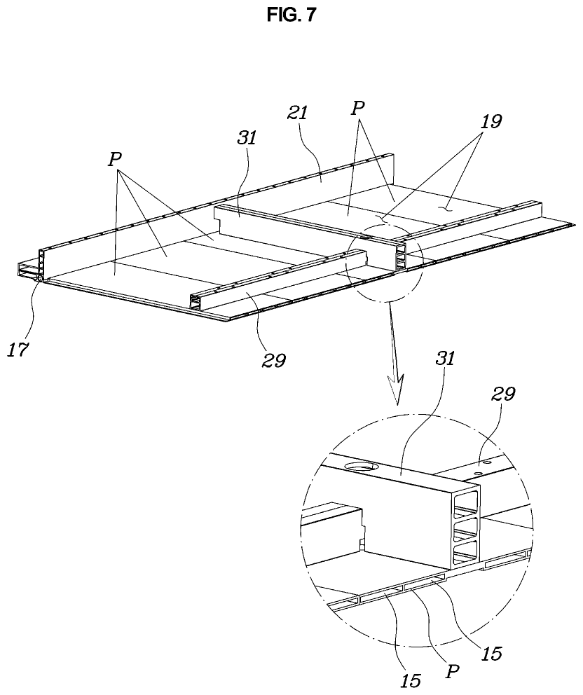

FIG. 6 is a perspective view of the battery pack structure cut along line VI-VI of FIG. 5, and FIG. 7 is a perspective view of the battery pack structure cut along line VII-VII of FIG. 5.

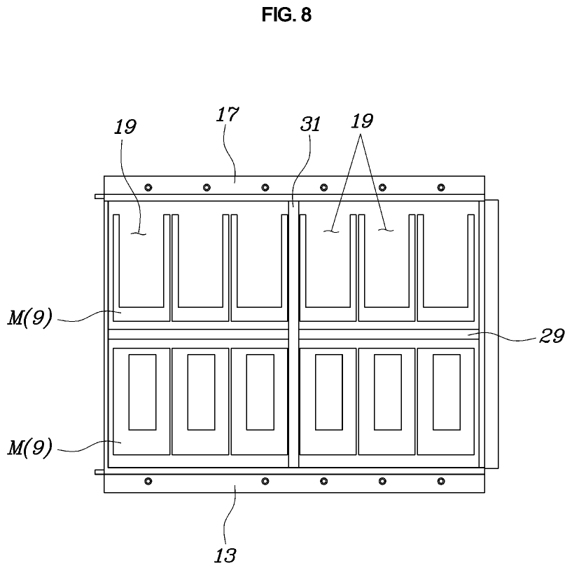

FIG. 8 is a view illustrating the battery pack structure with only the first insulator 9 of FIG. 4, in which the first insulator 9 is provided above a cooling plane 19.

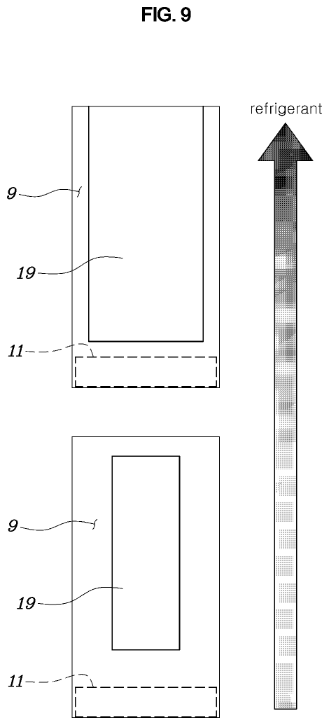

FIG. 9 is a partial enlarged view of FIG. 8, depicting a structure in which the first insulators 9 are provided below two battery modules 5 disposed along the lengthwise direction of the cooling channel 15.

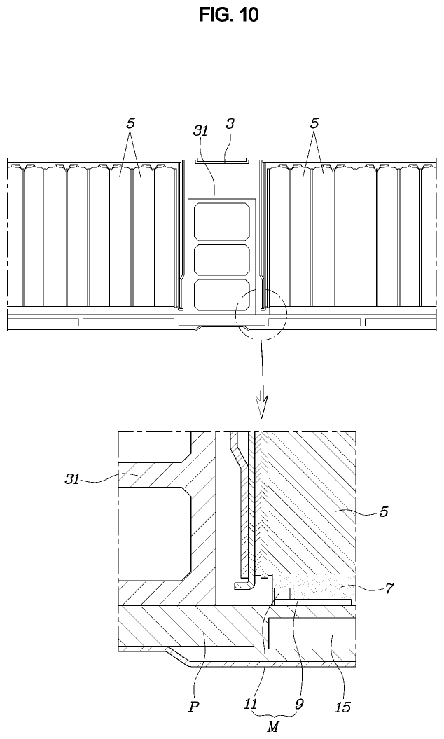

FIG. 10 is a cross-sectional view taken along line X-X of FIG. 4.

Referring to FIGS. 1 to 10, a battery pack 1 for a vehicle according to an embodiment of the disclosure is structured to include a supplying channel 13 provided to supply a refrigerant, a discharging channel 17 formed to make the refrigerant flow in parallel with the supplying channel 13, and a plurality of cooling channels 15 provided in parallel between the supplying channel 13 and the discharging channel 17 so that the refrigerant can flow under a plurality of battery modules 5 disposed between the supplying channel 13 and the discharging channel 17.

In other words, the refrigerant is supplied through the supplying channel 13, flows through the plurality of cooling channels 15 to cool the lower sides of the plurality of battery modules 5, and is then discharged to the outside through the discharging channel 17.

Each of the supplying channel 13 and the discharging channel 17 is formed to make the refrigerant flow straightly, and the plurality of cooling channels 15 connects the supplying channel 13 and the discharging channel 17 in straight lines, thereby forming a cooling plane 19 on the upper side thereof.

For reference, the term ‘channel’ is used herein to involve a passage itself for the refrigerant and peripheral structures forming the passage.

The plurality of battery modules 5 are mounted on the cooling plane 19, and an insulator M is provided below the plurality of battery modules 5 arranged in sequence along the lengthwise direction of the cooling channel 15 and causes a difference in heat transfer performance according to relative positions from the supplying channel 13.

In other words, the refrigerant passing through the cooling channel 15 is gradually increased in temperature while cooling the battery cells of the battery module 5. Because the refrigerant is gradually increased in temperature from the supplying channel 13 toward the discharging channel 17, the insulator M is used to intentionally cause the difference in the heat transfer performance according to the relative positions from the supplying channel 13 in order to evenly cool the battery cells of the battery modules 5 disposed along the lengthwise direction of the cooling channel 15.

The insulator M may be disposed forming layers as heterogeneous materials in the cooling plane 19 on the cooling channel 15.

In other words, the insulator M may include a first insulator 9 attached to the cooling plane 19 and a second insulator 11 attached to the top of the first insulator 9.

Here, the first insulator 9 is attached along the outward portion shape of the bottom of the battery module 5 and has a narrower area as it is positioned further away from the supplying channel 13.

FIG. 9 illustrates that the first insulators 9 are provided in the cooling plane 19 corresponding to the bottoms of two battery modules 5 to be cooled by the refrigerant flowing from the supplying channel 13 toward the discharging channel 17 through the cooling channel 15, in which the first insulator 9 is attached along the outward portion shape of the bottom of the battery module 5.

As described above, the first insulator 9 is provided along the outward portion shape of the bottom of the battery module 5 in order to reduce the difference in temperature between the central portion and the outward portion of the battery module 5 because the central portion of the battery module 5 has a higher temperature than the outward portion due to structural difficulty in heat dissipation.

Further, the first insulator 9 having a narrower area is attached to the bottom of the battery module 5 positioned further away from the supplying channel 13 in order to ultimately perform uniform cooling to the bottoms of all the battery modules 5 by narrowing the area of the first insulator 9 to raise the heat transfer performance between the refrigerant and the battery module 5 positioned further away from the supplying channel 13 because the refrigerant is increased in temperature as it is positioned further away from the supplying channel 13.

Meanwhile, the first insulator 9 attached along the outward portion shape of the bottom of the battery module 5 is formed so that the area in a portion further from the supplying channel 13 can be narrower than that in a portion closer to the supplying channel 13.

In other words, even in the first insulator 9 attached to the bottom of one battery module 5, the area in a portion farther from the supplying channel 13 is narrower than that in a portion closer to the supplying channel 13, thereby ultimately performing the uniform cooling throughout the battery modules 5.

Further, according to this embodiment, the first insulator 9 attached to the bottom of the battery module 5 closest to the discharging channel 17 among the plurality of battery modules 5 arranged in sequence along the lengthwise direction of the cooling channel 15 has a structure in which a portion closest to the discharging channel 17 is removed from portions corresponding to the outward portion shape of the bottom of the battery module 5 to form a U-shape.

In other words, the first insulator 9 provided corresponding to the bottom of the battery module 5 shown in an upper side of FIG. 9 has the U-shape as described above. Because the refrigerant flowing in the cooling channel 15 and passing by a portion of the first insulator 9 closest to the discharging channel 17 has the highest temperature, the portion of the first insulator 9 is removed to maximize the heat transfer performance between the battery module 5 and the refrigerant, thereby ultimately uniformizing the cooling performance on the bottoms of the battery modules 5 adjacent to the discharging channel 17.

The second insulator 11 attached to the top of the first insulator 9 is locally provided only on a portion closest to the supplying channel 13 among outward bottom portions of each battery module 5.

For reference, the second insulator 11 may be provided in a portion indicated by the dotted line of FIG. 9.

In this embodiment, the second insulator 11 is provided having the same shape as shown in FIG. 4.

Because the refrigerant flowing in the cooling channel 15 and passing by an outward bottom portion closest to the supplying channel 13 has the lowest temperature, the second insulator 11 is additionally provided in this portion to intentionally lower the heat transfer performance between the battery module 5 and the refrigerant, thereby ultimately securing the uniform cooling performance throughout the battery modules 5.

For reference, the first insulator 9 may include an insulation tape, MICA, etc., and the second insulator 11 may include polyurethane (PU)-foam, etc.

Meanwhile, a gap filler 7 is provided between the bottom of the battery module 5 and the cooling plane 19, between the bottom of the battery module 5 and the first insulator 9, and between the bottom of the battery module 5 and the second insulator 11.

In other words, the first insulator 9 is first provided on the cooling plane 19 formed on the top of the cooling channels 15, and the second insulator 11 is provided on the first insulator 9. The gap filler 7 is applied onto the cooling plane 19, the first insulator 9, and the second insulator 11, and then the battery module 5 is mounted onto the gap filler 7.

Therefore, the gaps between the battery module 5 and the first insulator 9, between the battery module 5 and the second insulator 11, and between the battery module 5 and the cooling plane 19 are filled with the gap filler 7, thereby forming a structure for more effectively transferring heat. The heat transfer performance of a portion where the first insulator 9 is added to the cooling plane 19 between the battery module 5 and the cooling channel 15 is lower than that of a portion where only the cooling plane 19 is provided, and the heat transfer performance of a portion where the second insulator 11 is added to the first insulator 9 is further lowered, so that the heat transfer performance between the bottom of the battery module 5 and the refrigerant flowing through the cooling channel 15 can be ultimately uniformized throughout portions.

Of course, the second insulator 11 may be eliminated as necessary, and only the first insulator 9 may be provided. In this case, the insulator M may be construed as including only the first insulator 9.

Meanwhile, the supplying channel 13 and the discharging channel 17 may be configured as both side members 21 of the battery pack 1, respectively.

In other words, the channels are formed in the side members 21 themselves, which make up the outer frame of the battery pack 1, so that the refrigerant can flow therein, thereby forming the supplying channel 13 and the discharging channel 17.

For reference, FIGS. 5 to 7 illustrate that the cooling channel 15 is separately manufactured and forms a lower portion of the side member 2. Alternatively, the cooling channel 15 and the side member 21 may be formed as a single body.

The cooling plane 19 formed by the plurality of cooling channels 15 is parallel to the lengthwise direction of both side members 21, and a frontward wall 23 and a rearward wall 25 are respectively provided in the fronts and rears of both side members 21, so that the plurality of battery modules 5 can be accommodated in an accommodating space 27 formed by both side members 21, the frontward wall 23, and the rearward wall 25.

Meanwhile, the battery pack 1 according to embodiments of the disclosure includes a single longitudinal member 28, both ends of which are supported on the frontward wall 23 and the rearward wall 25 across the accommodating space 27, and a single transverse member 31 having both ends supported on both side members 21 across the accommodating space 27 and intersecting the longitudinal member 29.

Therefore, the battery pack 1 according to embodiments of the disclosure requires a relatively small space to be occupied by the longitudinal member 29 and the transverse member 31, thereby allowing the unoccupied space to accommodate more battery cells and ultimately contributing to increasing the range of a vehicle.

Meanwhile, the cooling channel 15 is formed by a plurality of extruded panels P provided on the lower side of the accommodating space 27, and the cooling plane 19 is formed by the top surface of the plurality of extruded panels. As described above, the plurality of extruded panels making up the cooling channel 15 may greatly help to secure sufficient rigidity against a lateral collision of the battery pack 1.

Although specific embodiments of the disclosure have been illustrated and described as above, various modifications and changes can be made by a person having ordinary knowledge in the art without departing from the scope of technical ideas defined by the appended claims.

What is claimed is:

1. A battery pack structure for a vehicle, the structure comprising:
a supplying channel configured to supply a refrigerant;
a discharging channel disposed such that the refrigerant flows therein in parallel with the supplying channel; and
a plurality of cooling channels disposed in parallel between the supplying channel and the discharging channel such that the refrigerant can flow under a plurality of battery modules disposed between the supplying channel and the discharging channel.

2. The structure of claim 1, wherein:
each of the supplying channel and the discharging channel is disposed to make the refrigerant flow straightly; and
the plurality of cooling channels connects the supplying channel and the discharging channel in straight lines to define a cooling plane on an upper side thereof.

3. The structure of claim 2, wherein:
the plurality of battery modules is mounted on the cooling plane; and
an insulator is disposed below the plurality of battery modules arranged in sequence along a lengthwise direction of the cooling channels and is configured to cause a difference in heat transfer performance according to relative positions from the supplying channel.

4. The structure of claim 3, wherein the insulator is disposed as layers of heterogeneous materials in the cooling plane.

5. The structure of claim 4, wherein the insulator comprises:
a first insulator attached to the cooling plane; and
a second insulator attached to a top of the first insulator.

6. The structure of claim 5, wherein the first insulator is attached along an outward portion shape of a bottom of the battery modules and has a narrower area as a distance between the first insulator and the supplying channel increases.

7. The structure of claim 6, wherein the first insulator attached along the outward portion shape of the bottom of the battery modules is shaped so that an area in a portion further from the supplying channel is narrower than an area in a portion closer to the supplying channel.

8. The structure of claim 7, wherein the first insulator attached to the bottom of the battery module closest to the discharging channel among the plurality of battery modules arranged in sequence along the lengthwise direction of the cooling channel has a structure in which a portion closest to the discharging channel is removed from portions corresponding to the outward portion shape of the bottom of the battery modules to define a U-shape.

9. The structure of claim 7, wherein the second insulator attached to the top of the first insulator is locally disposed only on a portion closest to the supplying channel among outward bottom portions of each battery module.

10. The structure of claim 5, further comprising a gap filler between a bottom of the battery modules and the cooling plane, between the bottom of the battery modules and the first insulator, and between the bottom of the battery modules and the second insulator.

11. A battery pack structure for a vehicle, the structure comprising:
a supplying channel configured to supply a refrigerant;
a discharging channel disposed such that the refrigerant flows therein in parallel with the supplying channel, wherein each of the supplying channel and the discharging channel is disposed to make the refrigerant flow straightly;
a plurality of cooling channels disposed in parallel between the supplying channel and the discharging channel such that the refrigerant can flow under a plurality of battery modules mounted on a cooling plane between the supplying channel and the discharging channel, wherein the plurality of cooling channels connects the supplying channel and the discharging channel in straight lines to define the cooling plane on an upper side thereof; and
an insulator disposed below the plurality of battery modules arranged in sequence along a lengthwise direction of the cooling channel and configured to cause a difference in heat transfer performance according to relative positions from the supplying channel, wherein the insulator is attached along an outward portion shape of a bottom of the battery module and has a narrower area as a distance between the insulator and the supplying channel increases.

12. The structure of claim 11, wherein the insulator disposed along the outward portion shape of the bottom of the battery modules is disposed so that an area in a portion further from the supplying channel is narrower than an area in a portion closer to the supplying channel.

13. The structure of claim 12, wherein the insulator attached to the bottom of the battery module closest to the discharging channel among the plurality of battery modules arranged in sequence along the lengthwise direction of the cooling channels has a structure in which a portion closest to the discharging channel is removed from portions corresponding to the outward portion shape of the bottom of the battery modules to define a U-shape.

14. The structure of claim 13, wherein:
the insulator is attached to the cooling plane defined by the plurality of cooling channels; and
a gap filler is disposed between the bottom of the battery module and the cooling plane and between the bottom of the battery module and the insulator.

15. A battery pack structure for a vehicle, the structure comprising:
a supplying channel configured to supply a refrigerant;
a discharging channel disposed such that the refrigerant flows therein in parallel with the supplying channel, wherein each of the supplying channel and the discharging channel is disposed to make the refrigerant flow straightly, and wherein the supplying channel and the discharging channel are configured as both side members of a battery pack, respectively;
a plurality of cooling channels disposed in parallel between the supplying channel and the discharging channel such that the refrigerant can flow under a plurality of battery modules mounted on a cooling plane between the supplying channel and the discharging channel, wherein the plurality of cooling channels connects the supplying channel and the discharging channel in straight lines to define the cooling plane on an upper side thereof; and
an insulator disposed below the plurality of battery modules arranged in sequence along a lengthwise direction of the cooling channel and configured to cause a difference in heat transfer performance according to relative positions from the supplying channel.

16. The structure of claim 15, wherein the cooling plane defined by the plurality of cooling channels is parallel to a lengthwise direction of both side members.

17. The structure of claim 16, further comprising a frontward wall and a rearward wall respectively disposed in front of and to a rear of both side members, wherein the plurality of battery modules can be accommodated in an accommodating space defined by both side members, the frontward wall, and the rearward wall.

18. The structure of claim 17, further comprising:
a single longitudinal member having both ends respectively supported on the frontward wall and the rearward wall across the accommodating space; and
a single transverse member having both ends respectively supported on both side members across the accommodating space and intersecting the single longitudinal member.

19. The structure of claim 18, wherein the plurality of cooling channels is defined by a plurality of extruded panels disposed on a lower side of the accommodating space, and the cooling plane is defined by a top surface of the plurality of extruded panels.

20. The structure of claim 15, wherein the insulator is disposed as layers of heterogeneous materials in the cooling plane.
